(19) United States
(12) Patent Application Publication
(10) Pub. No.: US 2022/0321742 A1
(43) Pub. Date: Oct. 6, 2022

(54) IMAGE PROCESSING APPARATUS THAT CARRIES OUT NOISE REDUCTION PROCESS WHEN PLAYING VIDEO, IMAGE PROCESSING METHOD, AND STORAGE MEDIUM

(71) Applicant: CANON KABUSHIKI KAISHA, Tokyo (JP)

(72) Inventors: Hidetaka Uemura, Kanagawa (JP); Toshio Minoshima, Kanagawa (JP); Takayuki Sudo, Kanagawa (JP)

(21) Appl. No.: 17/702,532

(22) Filed: Mar. 23, 2022

(30) Foreign Application Priority Data
Mar. 30, 2021 (JP) 2021-057794

(51) Int. Cl. H04N 5/213; G06T 5/50; G06T 5/00

(52) U.S. Cl. CPC H04N 5/213; G06T 5/50; G06T 5/002; G06T 2207/10016

(57) ABSTRACT

An apparatus that is capable of achieving the effect of a cyclic noise reduction process even for a first frame of video. The apparatus obtains video and subjects, when playing the video, a first frame for starting playing the video to the cyclic noise reduction process using one or more frames after the first frame.

### BACKGROUND

### Technical Field

The aspect of the embodiments relates to an image processing apparatus, an image processing method therefor, and a storage medium, and in particular to an image processing apparatus that carries out a noise reduction process when playing video, an image processing method, and a storage medium.

### Description of the Related Art

There is a technique with which shooting is performed using a camera capable of shooting video in RAW format (hereafter referred to as “RAW video”), and the shot RAW video is edited in a variety of ways. Information about an image signal generated by an image sensor of the camera is recorded the way it is in each of frames constituting the RAW video. The image quality of the RAW video can be freely adjusted by subjecting the RAW video to a developing process using the camera, a personal computer, or the like.

On the other hand, there is a known technique with which noise is reduced in each frame of video by a cyclic noise reduction process. The cyclic noise reduction process is a technique for reducing noise using correlation between a developed frame (image) and a frame (image) that is one or more frame periods before the developed frame and stored in memory.

As related arts, a technique described in Japanese Laid-Open Patent Publication (Kokai) No. H11-215403 and a technique described in Japanese Laid-Open Patent Publication (Kokai) No. 2013-239957 have been proposed. With the technique described in Japanese Laid-Open Patent Publication (Kokai) No. H11-215403, frame noise reduction based on frame correlation is performed. According to the technique described in Japanese Laid-Open Patent Publication (Kokai) No. 2013-239957, when a first video and a second video are sequentially played, a scene transition effect is applied to a video following the first video and a video preceding the second video over a period of time during which a scene is judged to be continuing.

As described above, the cyclic noise reduction process is the technique for reducing noise using correlation between one frame and a frame that is one or more frame periods before the frame. Thus, the cyclic noise reduction process cannot be carried out on a first frame among frames constituting a video because there is no frame before the first frame. For this reason, a problem arises due to worsening image quality of the first frame. The technique described in Japanese Laid-Open Patent Publication (Kokai) No. H11-215403 is not intended to reduce noise in the first frame. The technique described in Japanese Laid-Open Patent Publication (Kokai) No. 2013-239957 is not related to the cyclic noise reduction process. Moreover, the above problem may also arise in video other than the RAW video.

### SUMMARY

Accordingly, the aspect of the embodiments provides an image processing apparatus comprising at least one processor that performs to: obtain a video; and when playing the video, subject a first frame for starting playing the video to a cyclic noise reduction process using one or more frames after the first frame.

Further features of the disclosure will become apparent from the following description of exemplary embodiments (with reference to the attached drawings).

### BRIEF DESCRIPTION OF THE DRAWINGS

FIG. 1 is a block diagram showing an example of an arrangement of an image pickup apparatus.

FIG. 2 is a view showing an example of an arrangement of a video file.

FIG. 3 is a flowchart showing an example of a RAW video playing process according to a first embodiment.

FIG. 4 is a view showing an example of a process that is carried out in a case where a RAW video file starts playing from the beginning.

FIG. 5 is a view showing an example of a process that is carried out in a case where a RAW video file starts playing from the middle.

FIG. 6 is a view showing an example of a process that is carried out in a case where a RAW video file generated by recording using long exposure is played.

FIG. 7 is a view showing an example in which videos are combined, and a video obtained by combining the videos is played.

FIG. 8 is a flowchart showing an example of the flow of a process in which a combined video is played according to a second embodiment.

FIG. 9 is a view showing an example of a proxy video file created when a pendulum is shot, and an example of a RAW video file when it is played.

FIG. 10 is a view showing an example of an arrangement of a control unit according to a third embodiment.

FIG. 11 is a flowchart showing the flow of a RAW video playing process according to the third embodiment.

FIG. 12 is view showing examples of arrangements of an image signal processing circuit and a control unit according to a fourth embodiment.

FIG. 13 is a flowchart showing the flow of a RAW video playing process according to the fourth embodiment.

FIG. 14 is a view showing an example of an arrangement of a control unit according to a fifth embodiment.

FIG. 15 is a flowchart showing the flow of a RAW video recording process according to the fifth embodiment.

FIG. 16 is a view showing a first example of the RAW video recording process.

FIG. 17 is a view showing a second example of the RAW video recording process.

FIGS. 18A and 18B are views showing examples of a video selection screen.

### DESCRIPTION OF THE EMBODIMENTS

The disclosure will now be described in detail below with reference to the accompanying drawings showing embodiments thereof.

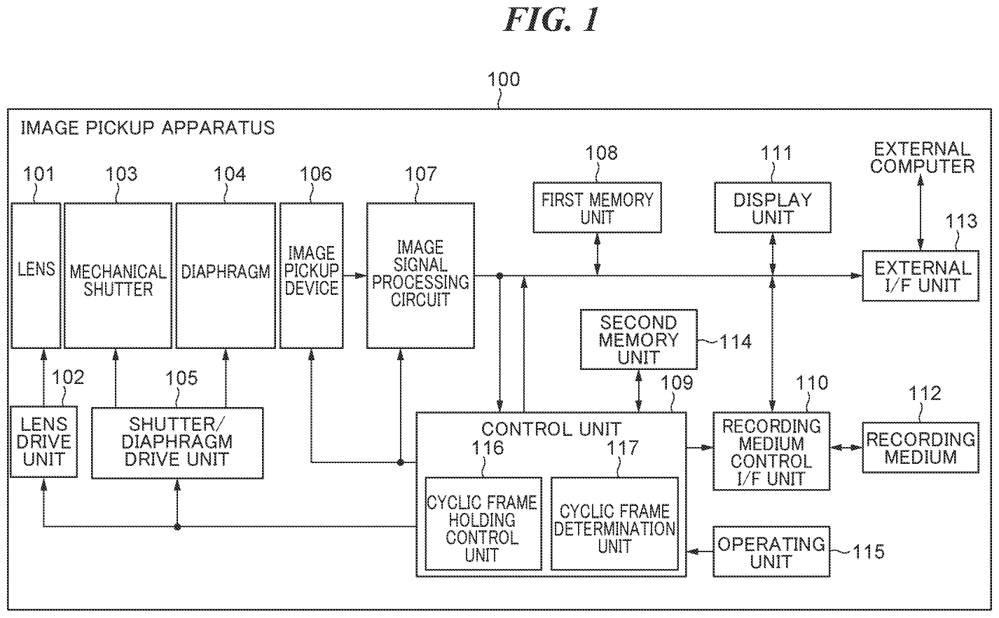

FIG. 1 is a block diagram showing an example of an arrangement of an image pickup apparatus 100. The image pickup apparatus 100 includes a lens 101, a lens drive unit 102, a mechanical shutter 103, a diaphragm 104, and a shutter/diaphragm drive unit 105 (mechanical shutter/diaphragm drive unit). The image pickup apparatus 100 includes an image pickup device 106, an image signal processing circuit 107, a first memory unit 108, a control unit 109, and a recording medium control I/F unit 110. The image pickup apparatus 100 includes a display unit 111, a recording medium 112, an external I/F unit 113, a second memory unit 114, and an operating unit 115. I/F stands for an interface.

The lens drive unit 102 controls zoom, focus, etc. of the lens 101. A subject image entering through the lens 101 is adjusted to have an appropriate amount of light by the diaphragm 104 and formed on an imaging surface on the image pickup device 106. The subject image formed on the imaging surface on the image pickup device 106 is photoelectrically converted. The subject image that has been photoelectrically converted is subjected to, for example, a gain adjustment process and an A/D conversion process in which an analog signal is converted into a digital signal. A digital signal obtained by an analog signal being converted is sent as, for example, R, Gr, Gb, or B image signal to the image signal processing circuit 107. The image signal processing circuit 107 carries out various types of image signal processing such as a developing process, a low-pass filtering process that reduces noise, a shading process, white balance (WB) process, and a cyclic noise reduction process. The image signal processing circuit 107 also performs various types of correction, compression of image data, and so forth.

Operation of the mechanical shutter 103 and the diaphragm 104 is controlled by the shutter/diaphragm drive unit 105. The control unit 109 controls the entire image pickup apparatus 100 and performs various types of computations. The first memory unit 108 stores image data. The recording medium control I/F unit 110 records image data onto and reads image data from the recording medium 112. The display unit 111 displays images and various types of information. The recording medium 112, which is a removable recording medium such as a semiconductor memory, records image data and various types of information. The external I/F unit 113 is an interface for carrying out communications with external apparatuses such as an external computer. The second memory unit 114 stores results of computations performed by the control unit 109.

The control unit 109 is implemented by, for example, a CPU. In each embodiment, control is implemented by a CPU, which performs functions of the control unit 109, executing predetermine programs. The functions of the control unit 109 may be implemented by predetermined circuits as well. The control unit 109 functions as an image processing apparatus. The first memory unit 108 and the second memory unit 114 may be either separate memories as shown in FIG. 1 or a single memory.

The operating unit 115 is a member that can be operated by a user. Information about driving conditions for the image pickup apparatus 100, which is input by the user via the operating unit 115, is sent to the control unit 109. Based on the received information, the control unit 109 controls the overall operation of the image pickup apparatus 100. The operating unit 115 and the display unit 111 may be an integral touch panel display. The control unit 109 includes a cyclic frame holding control unit 116 and a cyclic frame determination unit 117. The cyclic frame holding control unit 116 causes the first memory unit 108 to hold image data of frames for use in the cyclic noise reduction process. In the following description, the cyclic noise reduction process may be referred to as “the cyclic NR process” as well. Based on a frame number, the cyclic frame determination unit 117 determines image data of frames for use in the cyclic NR process. The image data of frames for use in the cyclic NR process may be determined based on something other than the frame number.

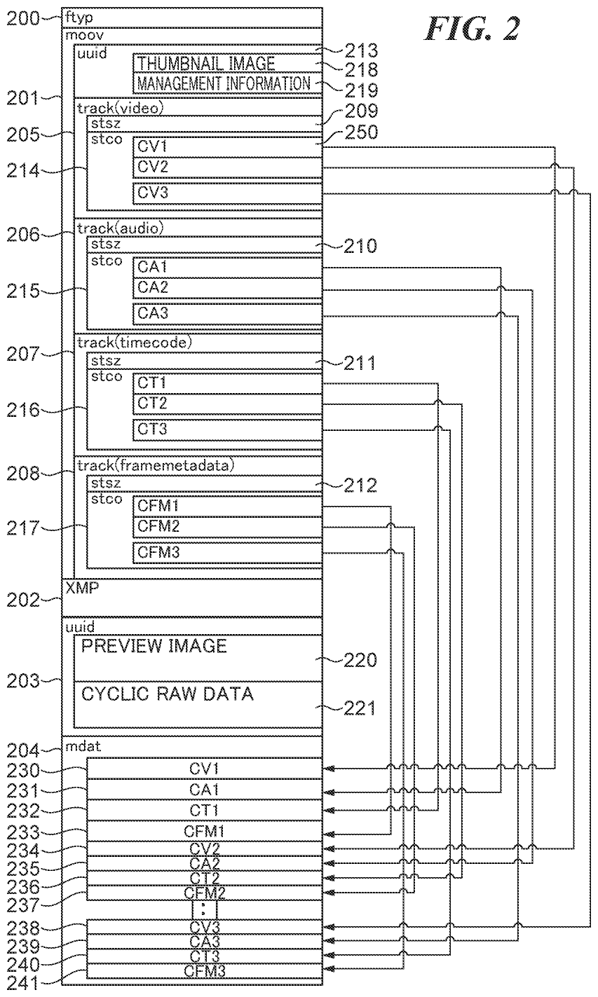

FIG. 2 is a view showing an example of an arrangement of a video file. The video file includes various types of boxes. An ftyp box 200 indicates file format compatibility. A moov box 201 is a box in which management information required for playing and a thumbnail image are stored. An XMP box 202 is a box in which an XMP (Extensible Metadata Platform) is stored, and arbitrary metadata can be set. A uuid box 203 is a box in which arbitrary information can be additionally stored. For RAW video, a preview image 220 is stored in the uuid box 203. Cyclic RAW data 221 may also be stored in the uuid box 203. Coded image data, audio data, time code data, and frame-by-frame metadata are stored in an mdat box 204.

A description will now be given of a configuration of the moov box 201. Arbitrary information such as a thumbnail image 218, which is displayed when playing video, and management information 219, which is used when playing, can be additionally stored in a uuid box 213 included in the moov box 201.

Management information about image data, audio data, time code data, frame-by-frame metadata, and so forth is stored in track boxes 205 to 208. Data sizes of image data, audio data, time code data, frame-by-frame metadata, and so forth in each coding unit are stored in stsz boxes 209 to 212. Information indicating storage locations in the mdat box 204 at which the image data, audio data, time code data, and frame-by-frame metadata are stored in the track boxes 205 to 208 is stored in the stco boxes 214 to 217. In the mdat box 204, data are stored in units called chunks comprised of one or more coding units.

A configuration of the mdat box 204 will now be described. Metadata 230 to 241 are image data, audio data, time code data, frame-by-frame metadata and so forth written in the mdat box 204. The data can be accessed on a chunk-by-chunk basis based on values written in respective stco boxes. For example, the metadata 230 (CV1) can be tracked from CV1 in the stco box 214. It should be noted that the configuration of the video file is not limited to the example in FIG. 2.

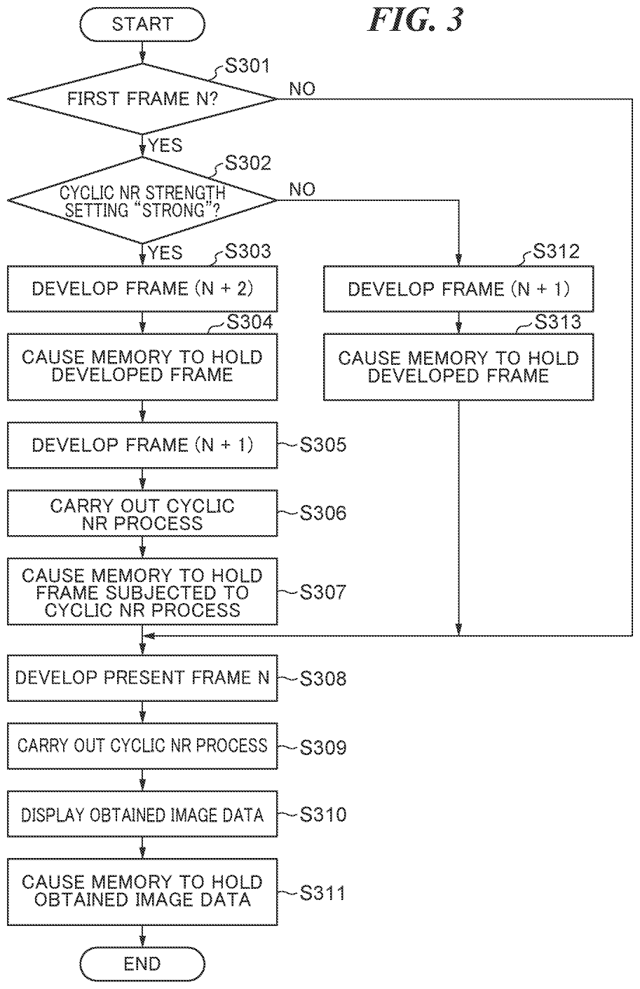

FIG. 3 is a flowchart showing an example of a RAW video playing process according to a first embodiment. Processes described in flowcharts according to respective embodiments are implemented by the control unit 109 executing predetermined programs. The process in the flowchart of FIG. 3 is started by, for example, the user selecting a RAW video and issuing an instruction to start playing it by means of the operating unit 115. At this time, the control unit 109 controls the recording medium control I/F unit 110 to start reading a selected RAW video file from the recording medium 112 and obtain the RAW video file. The control unit 109 then carries out the process in the flowchart in FIG. 3 for the read RAW video file, on a frame-by-frame basis.

Although the process in the flowchart of FIG. 3 is carried out (implemented) by the control unit 109 of the image pickup apparatus 100, the process in the flowchart of FIG. 3 may be carried out by apparatuses other than the image pickup apparatus 100. For example, an external apparatus (for example, a personal computer) obtains a RAW video file via the recording medium 112 or the external I/F unit 113. And subsequently the external apparatus may also carry out the process in the flowchart of FIG. 3 for the obtained RAW video file. In this case, the external apparatus functions as the control unit 109 (the image processing apparatus).

In S301, the cyclic frame determination unit 117 of the control unit 109 judges whether or not a present frame N among a plurality of frames constituting a video to be played is a first frame N (N is a natural number). When the result of the judgment in S301 is Yes (when it is judged that the present frame N is the first frame N), the control unit 109 lets the process proceed to S302. When the result of the judgment in S301 is No (when it is judged that the present frame N is not the first frame N), the control unit 109 lets the process proceed to S308.

In S302, the control unit 109 judges whether a cyclic NR strength setting is “Strong” or not (“Strong” or “Weak”). When the result of the judgment in S302 is Yes (when it is judged that the cyclic NR strength setting is “Strong”), the control unit 109 lets the process proceed to S303. In S303, the control unit 109 reads a frame (N+2) two frames after the first frame N from the RAW video file and causes the image signal processing circuit 107 to carry out the developing process on the read frame (N+2). In S304, the control unit 109 causes the first memory unit 108 to hold the frame (frame (N+2)), which has been subjected to the developing process, via the cyclic frame holding control unit 116.

In S305, the control unit 109 reads a frame (N+1) one frame after the first frame N from the video file and causes the image signal processing circuit 107 to carry out the development process on the read frame (N+1). In S306, the control unit 109 subjects the frame (N+1) developed in S305 to the cyclic NR process using the frame (N+2) held in the first memory unit 108 in S304. As a result of the cyclic NR process carried out using the two consecutive frames, various types of noise in a time direction can be reduced. In S307, the control unit 109 causes the first memory unit 108 to hold the frame (N+1), which has been subjected to the cyclic NR process, via the cyclic frame holding control unit 116.

In S308, the control unit 109 causes the image signal processing circuit 107 to carry out the developing process on the present frame N. In S309, the control unit 109 subjects the present frame N, which was subjected to the developing process in S308, to the cyclic NR process using the frame (N+1) held in the first memory unit 108. In S310, the control unit 109 causes the display unit 111 to display image data in the frame N obtained by carrying out the cyclic NR process on the present frame N. In S311, the cyclic frame holding control unit 116 of the control unit 109 causes the first memory unit 108 to hold the image data in the frame N, which was obtained by carrying out the cyclic NR process on the present frame N.

When the result of the judgment in S302 is No (when it is judged that the cyclic NR strength setting is not “Strong”), the control unit 109 lets the process proceed to S312. In S312, the control unit 109 reads a frame (N+1) one frame after the present frame N (the first frame N) from the RAW video file and causes the image signal processing circuit 107 to carry out the developing process on the read frame (N+1). In S313, the control unit 109 causes the first memory unit 108 to hold the frame (N+1), which has been subjected to the developing process, via the cyclic frame holding control unit 116. The control unit 109 then lets the process proceed to S308. After that, the control unit 109 carries out the processes in S308 and the subsequent steps.

As described above, the control unit 109 subjects the present frame N (the first frame N) to the cyclic NR process using a frame played backward (treating a frame after the frame N as a frame before the frame N). Conventionally, the cyclic NR process is a method that reduces noise using the correlation between the present frame and the immediately preceding frame. Namely, to carry out the cyclic NR process on one frame, a frame that is immediately preceding that frame is needed. However, there is no frame before the first frame in a RAW video file, and hence the cyclic NR process cannot be carried out on the first frame. Therefore, in the present embodiment, the control unit 109 carries out the cyclic NR process on the first frame N using one or more frames after the first frame N. As a result, when video is played, the cyclic NR process can be carried out on the first frame N as well, and this improves the image quality of the first frame N. Accordingly, the image quality of the video as a whole is also improved.

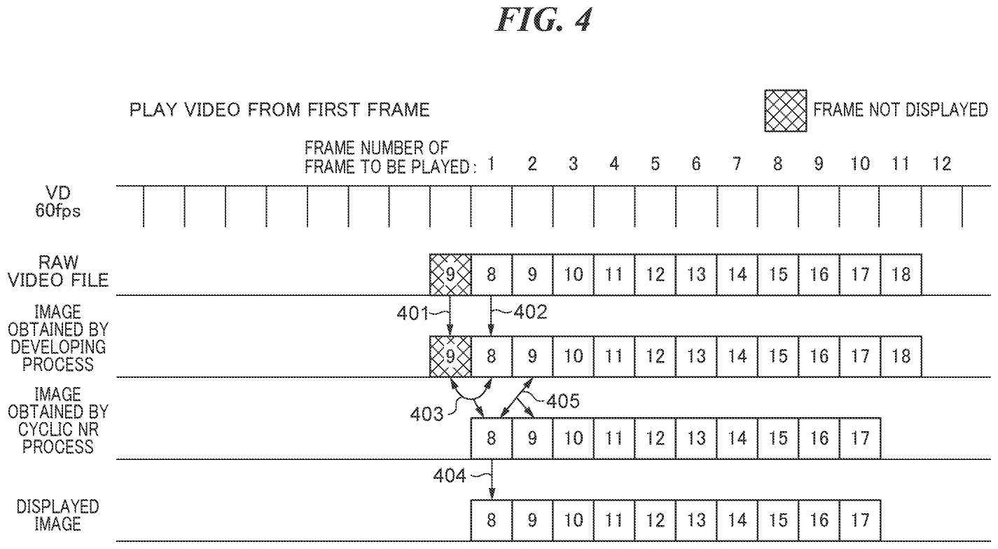

FIG. 4 is a view showing an example of a process that is carried out in a case where a RAW video file starts playing from the beginning. In FIG. 4, a play frame 1 (first frame) in the RAW video file is a frame 8 (N=8). When the cyclic NR strength setting is “Weak”, the control unit 109 reads a frame 9 next to the first frame, and as indicated by an arrow 401, carries out the developing process on the read frame 9. Image data in the frame 9 obtained by the developing process is held in the first memory unit 108.

Next, the control unit 109 reads image data corresponding to the frame 8 (the first frame 8), and as indicated by an arrow 402, carries out the developing process on the read frame 8. Namely, the developing process on the frame 9 read from the RAW video file is carried out prior to the first frame 8. As indicated by an arrow 403, the control unit 109 carries out the cyclic NR process on the first frame 8, which was subjected to the developing process, using the frame 9 held in the first memory unit 108. As a result, image data in the frame 8 subjected to the developing process is generated. The generated image data in the frame 8 is displayed as a display image on the display unit 111, as indicated by an arrow 404. The image data in the frame 8 subjected to the developing process is held in the first memory unit 108.

For frames following the first frame, the control unit 109, on a frame-by-frame basis, carries out the cyclic NR process on an image in the present frame using an image in the immediately preceding frame subjected to the cyclic NR process, as indicated by an arrow 405. In the example shown in FIG. 4, for the second frame (frame 9), the control unit 109 carries out the cyclic NR process using the present frame (frame 9) and the immediately preceding frame (frame 8) subjected to the cyclic NR process. Thus, the cyclic NR process is successively carried out on frames following the first frame. It should be noted that the “Next frame” and the subsequent frames used in the cyclic NR process on the first frame are not displayed.

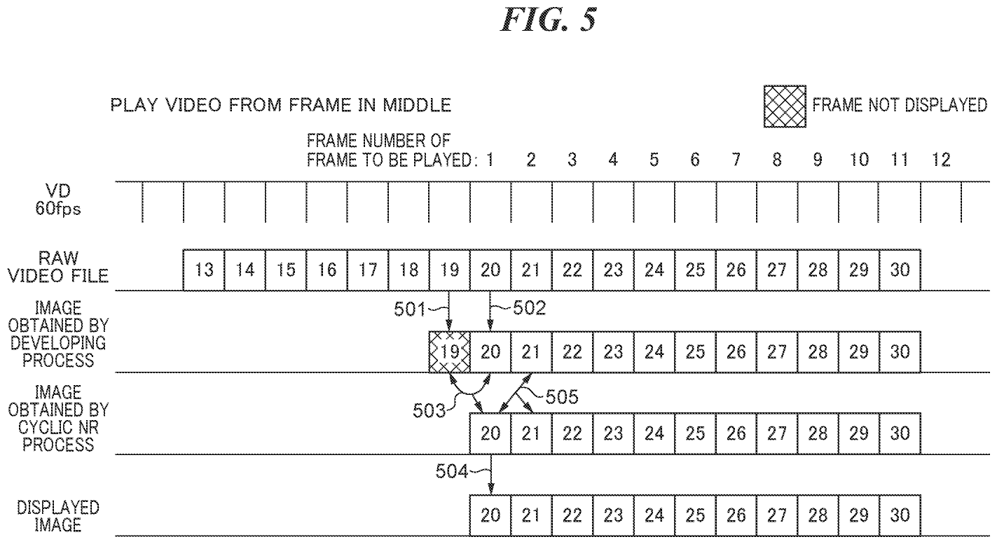

FIG. 5 is a view showing an example of a process that is carried out in a case where a RAW video file starts playing from the middle. In the example shown in FIG. 5, the RAW video file starts playing from a frame 20 in the middle of the RAW video file. When the cyclic NR strength setting is “Weak”, the control unit 109 reads a frame 19 immediately preceding the frame 20, and as indicated by an arrow 501, carries out the developing process on the read frame 19. Image data in the frame 19 obtained by the developing process is held in the first memory unit 108.

The control unit 109 also reads the frame 20 as a play frame 1, and as indicated by an arrow 502, carries out the developing process on the read frame 20. As indicated by an arrow 503, the control unit 109 carries out the cyclic NR process on the frame 20, which was subjected to the developing process, using the frame 19 held in the first memory unit 19. As a result, image data in the frame 20 subjected to the cyclic NR process is generated. The image data in the frame 20 subjected to the cyclic NR process is displayed as a display image on the display unit 111, as indicated by an arrow 504. The image data in the frame 20 subjected to the cyclic NR process is held in the first memory unit 108.

For frames following the frame 20, the same process as in the example shown in FIG. 4 is carried out. Namely, the control unit 109, on a frame-by-frame basis, carries out the cyclic NR process on the present frame, which was subjected to the developing process, using the immediately preceding frame subjected to the cyclic NR process, as indicated by an arrow 505. Thus, even in the case where a RAW video file starts playing from the middle, the cyclic NR process can be successively carried out using a middle frame, from which the RAW video file starts playing, as the first frame.

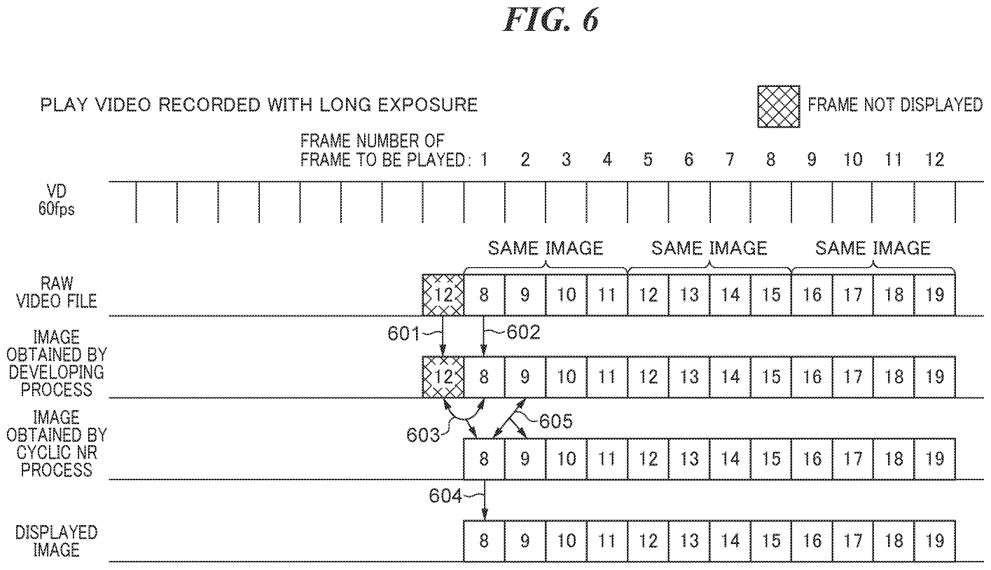

FIG. 6 is a view showing an example of a process that is carried out in a case where a RAW video file generated by recording using long exposure is played. In the example shown in FIG. 6, it is assumed that in the RAW video file, the same image data in four frames is recorded using long exposure. When the cyclic NR strength setting is “Weak”, the control unit 109 reads a frame 12, which lies after four frames accumulated by long exposure from a frame 8 as a frame immediately preceding the frame 8. Namely, in the cyclic NR process, the control unit 109 uses one or more frames that lie after the number of frames accumulated according to an exposure time period from the first frame. As indicated by an arrow 601, the control unit 109 carries out the developing process on the read frame 12. Image data in the frame 12 obtained by the developing process is held in the first memory unit 108.

The control unit 109 also reads the frame 8, and as indicated by an arrow 602, carries out the developing process on the read frame 8. At this time, the control unit 109 treats the read frame 8 as a play frame 1. As indicated by an arrow 603, the control unit 109 carries out the cyclic NR process on the frame 8, which has been subjected to the developing process, using the frame 12 held in the first memory unit 108. As a result, image data in the frame 8 subjected to the cyclic NR process is generated. The generated image data in the frame 8 subjected to the cyclic NR process is displayed as a display image on the display unit 111, as indicated by an arrow 604. The image data in the frame 8 subjected to the cyclic NR process is held in the first memory unit 108.

For frames following the frame 9, the same cyclic NR process as in the examples shown in FIG. 4 and FIG. 5 is carried out. Thus, even in the case where a RAW video file generated by recording using long exposure is played, the cyclic NR process can be successively carried out for the first frame and the subsequent frames.

Although the case where the cyclic NR strength setting is “Weak” has been described with reference to FIGS. 4 to 6, the examples in FIGS. 4 to 6 may also be applied to the case where the cyclic NR strength setting is “Strong”. Moreover, although in the flowchart of FIG. 3, the number of frames played backward (the number of frames used for the cyclic NR process) is two, the number of frames played backward may be three or more. In this case, the processes in S303 to S307 are repeatedly carried out a number of times corresponding to the number of frames played backward. If the number of frames played backward is too large, the time that elapses until video starts playing is long. For this reason, a predetermined limit may be placed on the number of frames played backward (i.e. the number of frames used for the cyclic NR process).

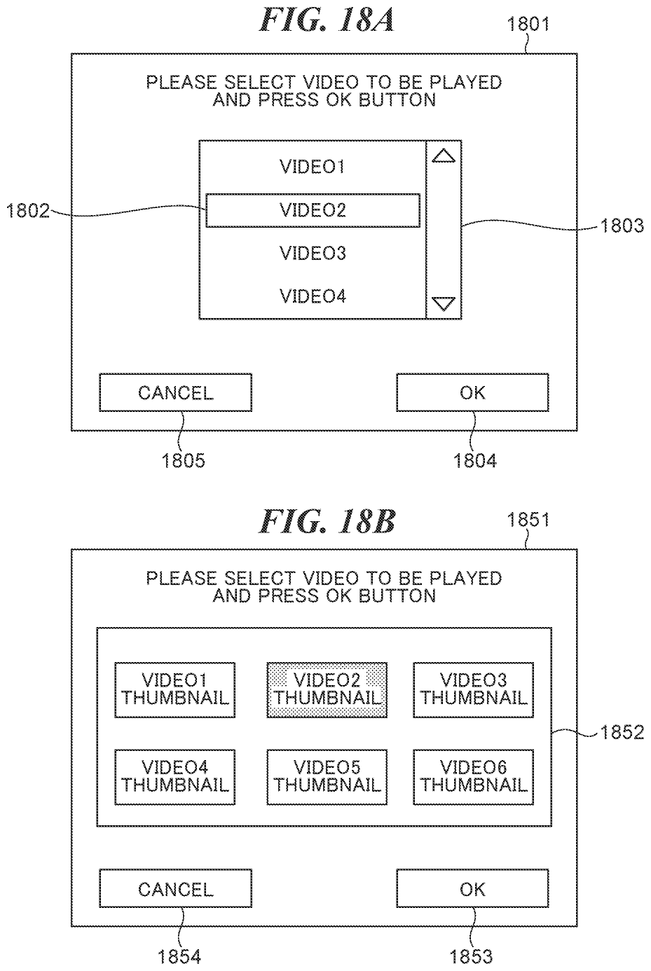

The control unit 109 may cause the display unit 111 to display a video selection screen. FIGS. 18A and 18B are views showing examples of the video selection screen. The video selection screen is a screen for selecting a video file to be played from a plurality of video files. A video selection screen 1801 in FIG. 18A includes a cursor 1802, a cursor moving area 1803, an OK button 1804, and a cancel button 1805. The user can select a video to be played via the operating unit 115. The cursor 1802 indicates a video currently selected among a plurality of videos. The user can change videos to be played by operating the cursor moving area 1803 to move the cursor 1802 up and down on the operating unit 115. The OK button 1804 is a button for confirming a selection of a video to be played. A video to be played is not confirmed until the OK button 1804 is depressed. The cancel button 1805 is a button for shifting the display screen from the video selection screen 1801 to another screen.

A video selection screen 1851 in FIG. 18B is a screen for selecting a video to be played from a list of thumbnails. The video selection screen 1851 in FIG. 18B includes a thumbnail area 1852, an OK button 1853, and a cancel button 1854. The thumbnail area 1852 is an area where thumbnails for a plurality of videos are displayed. The OK button 1853 is the same as the OK button 1804 in FIG. 18A. The cancel button 1854 is the same as the cancel button 1805 in FIG. 18A. The user can select a video to be played from the plurality of thumbnails. In the example shown in FIG. 18B, a video 2 is currently selected.

On the video selection screen 1801 in FIG. 18A, after a video is selected, the selection of the video is confirmed by depressing the OK button 1804. Before the OK button 1804 is depressed, in a state where the video selection screen 1801 is displayed, the control unit 109 may carry out the developing process on one or more frames after the first frame of the currently selected video in advance, as same as the process described above. For example, in the example shown in FIG. 18A, a video 2 is currently selected, but the selection has not been confirmed yet. In this case, the control unit 109 carries out the developing process on a frame following the first frame of the currently selected video 2. As a result, image data in the frame following the first frame of the currently selected video 2 is generated. In response to the selection being confirmed by depressing the OK button 1804, the cyclic NR process is carried out on the first frame using the “Next frame” (one or more frames after the first frame) that has been subjected to the developing process. At the time when the selection is confirmed, a frame next to (following) the first frame of the video 2 has already been subjected to the developing process, and hence the time required for the cyclic NR process on the first frame can be shortened. Namely, when the selection of a video is confirmed, the video quickly starts playing.

Assume that before the OK button 1804 is depressed, the currently selected video is changed from the video 2 to a video 3 by an operation performed via the operating unit 115. In this case, the control unit 109 subjects the currently selected video 3 to the same process as the above-described process carried out on the video 2. As a result, the time required for the cyclic NR process on the first frame can be shortened, and hence when the selection of an arbitrary video is confirmed, the first frame can be quickly subjected to the cyclic NR process and the video can quickly start playing. Although the case where the video selection screen 1801 in FIG. 18A is used has been described, the same applies to the case where the video selection screen 1851 in FIG. 18B is used. It should be noted that the control unit 109 may change determinations as to whether or not to carry out the developing process for subjecting the first frame of a currently selected video to the cyclic NR process, according to the cyclic NR strength setting, that is, the number of frames played backward.

As described above, the control unit 109 uses one or more frames after the first frame in carrying out the cyclic NR process on the first frame when playing a video. As a result, the cyclic NR process can be carried out also on the first frame among frames constituting the video, and hence the effect of the noise reduction process can be obtained even for the first frame. Here, proxy video (video with a smaller number of pixels or in a smaller size than a RAW video) is often recorded as video for editing at the same time when RAW video is recorded. If the cyclic NR process has not been carried out on the first frame of the RAW video, the noise reduction effect for the RAW video is lower than that for the proxy video recorded at the same time when the RAW video is recorded.

However, in the present embodiment, the control unit 109 subjects the first frame to the cyclic NR process using one or more frames after the first frame as described above, and hence the RAW video can be played while the same level of noise reduction effect as for the proxy video is achieved.

Although the example in which RAW video is targeted for the process has been described, a target for the process may be video other than RAW video. For example, the process may also be applied to a case where the cyclic NR process is carried out on the first frame when an image that has not been subjected to the cyclic NR process or a video file recorded in an image format (RAW, YUV, etc.) is played. Moreover, the process carried out by the control unit 109 may be applied to a case where a predetermined editing process is to be carried out. Examples of the predetermined editing process include dividing/combining video files, transcoding in which a video file is recorded after its recording format, resolution, and frame rate are converted, and still image clipping in which one frame of RAW video is clipped to be recorded as a still image. In this case, the process in the flowchart of FIG. 3 is carried out in the case where the editing process is to be carried out. The above is common to all of the embodiments.

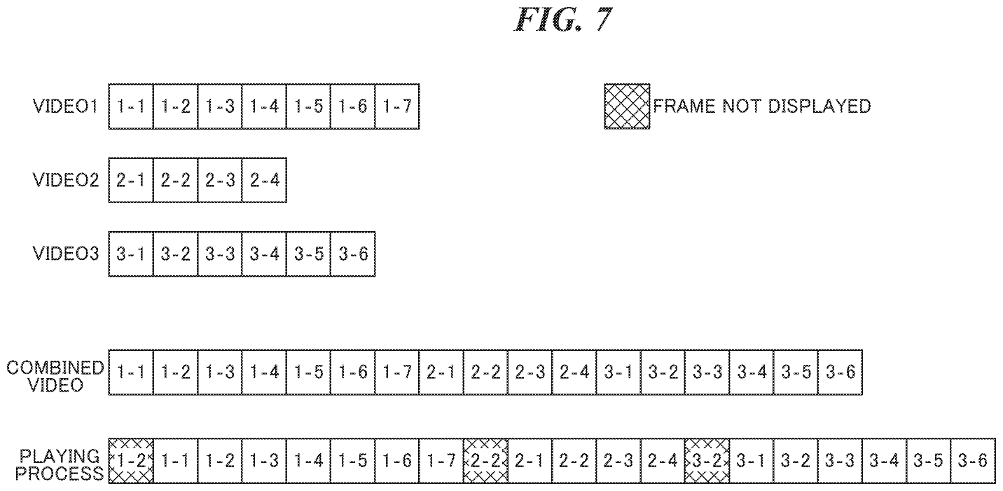

In a second embodiment, the control unit 109 combines a plurality of video files into one and plays a combined video file. FIG. 7 is a view showing an example in which videos are combined, and a video obtained by combining the videos (combined video) is played. In the example shown in FIG. 7, a video 1, a video 2, and a video 3 are combined in this order to form a combined video. In the present embodiment, the control unit 109 subjects the combined video to the same process as in the first embodiment.

To carry out the cyclic NR process on a first frame 1-1 of the video 1, the control unit 109 carries out the developing process on a frame 1-2 following the first frame 1-1 first. Likewise, to carry out the cyclic NR process on a first frame 2-1 of the video 2, the control unit 109 carries out the developing process on a frame 2-2 following the first frame 2-1 first. To carry out the cyclic NR process on a first frame 3-1 of the video 3, the control unit 109 carries out a developing process on a frame 3-2 following the first frame 3-1 first. The frames 1-2, 2-2, and 3-2 for use in carrying out (applied to) the cyclic NR process on the first frames 1-1, 2-1, and 3-1 are not displayed on the display unit 111.

Assume here that when the combined video has been played up to a point (a point of combination) at which the video 1 and the video 2 are combined together, the developing process is carried out on the frame 2-2 following the frame 2-1 so as to carry out the cyclic NR process on the first frame 2-1 of the video 2. In this case, the video playing pauses due to the frame 2-2 being subjected to the developing process. In the second embodiment, the control unit 109 completes the developing process on the combined frames 2-2 and 3-2 before the frames 2-2 and 3-2 of the combined video start playing. As a result, the same effects as those in the first embodiment can be obtained without pausing the video playing even in the case where the combined video is played.

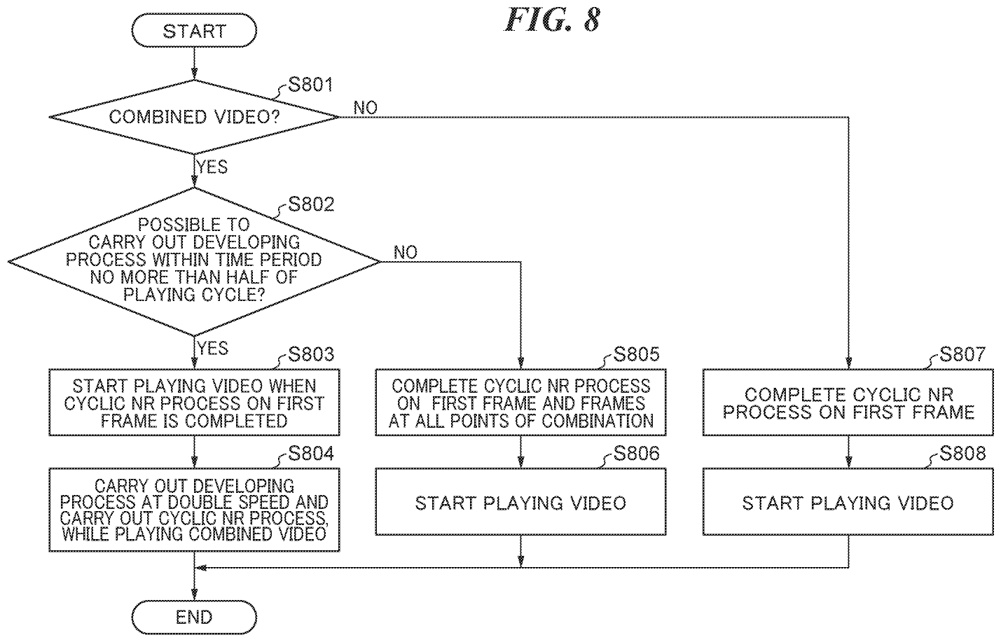

FIG. 8 is a flowchart showing an example of the flow of a process in which a combined video is played according to the second embodiment. In S801, the control unit 109 judges whether or not a RAW video to be played is a combined video. When the result of the judgment in S801 is Yes (when the video to be played is a combined video), the control unit 109 lets the process proceed to S802. In S802, the control unit 109 judges whether or not it is possible to carry out the developing process on each frame of the combined video at such a speed as to be completed within a time period no more than half of a playing cycle of the combined video. When the result of the judgment in S802 is Yes (when it is possible to carry out the developing process at such a speed that it can be completed within the time period no more than half of the playing cycle of the combined video), the control unit 109 lets the process proceed to S803.

In S803, when the cyclic NR process on a first frame has been completed, the control unit 109 starts playing the combined video. Namely, the above-described cyclic NR process is carried out on a first frame of a first video among videos constituting the combined video and completed. Then, the combined video is played. In S804, while playing the combined video, the control unit 109 carries out the developing process on frames following frames at points of combination, at twice the speed at which the combined video is played. Namely, while playing the combined video, the control unit 109 carries out the cyclic NR process on the frames at points of combination (first frames of respective videos constituting the combined video) in advance to complete preparation for playing.

Here, the process in S804 is carried out when the result of the judgment in S802 is Yes. For this reason, even in a case where a video to be played first in the combined video is comprised of two frames, the cyclic NR process has been completed at the time when a first frame (a frame at a point of combination) of the next video is played. Accordingly, since a preparation for playing frame at a point of combination has been completed at the time when the frame is played, the combined video being currently played is not paused. After the process in S804, the control unit 109 ends the process in the flowchart of FIG. 8.

When the result of the judgment in S802 is No (it is not possible to carry out the developing process at such a speed as to be completed within the time period no more than half of the playing cycle of the combined video), the control unit 109 lets the process proceed to S805. In S805, the control unit 109 completes the cyclic NR process on a first frame and frames at all points of combination (first frames of all videos constituting the combined video). By the process in S805 being carried out, the cyclic NR process on the first frame and the frames at the points of combination is completed to finish a preparation for playing of those frames before the combined video starts playing. In S806, the control unit 109 starts playing the combined video. At the time when a frame at a point of combination in the combined video is played, the cyclic NR process on the frame (a preparation for playing the frame) has been completed, and hence the combined video being currently played is not paused. After the process in S806, the control unit 109 ends the process in the flowchart of FIG. 8.

When the result of the judgment in S801 is No (when the video to be played is not a combined video), the control unit 109 lets the process proceed to S807. In this case, videos have not been combined together, and hence the cyclic NR process on frames at points of combination need not to be taken into consideration. In S807, the control unit 109 carries out the cyclic NR process on a first frame of the video to be played. The process in S807 is the same as the process in the first embodiment described above. As a result, the cyclic NR process on the first frame is completed. In S808, playing of the video is started. After the process in S808, the control unit 109 ends the process in the flowchart of FIG. 8.

In the example described above, in S804, the control unit 109 carries out the developing process on a frame following a frame at a point of combination (first frames of videos constituting the combined video or a first frame of “Next video”) in advance to generate images subjected to the cyclic NR process (post-cyclic NR-processed images). Alternatively, the control unit 109 may carry out the developing process on “Next frame” following frames at points of combination in advance and carry out the developing process and the cyclic NR process on the frames at the points of combination in real time.

In a third embodiment, the strength of the cyclic NR process carried out on a first frame a RAW video when the RAW video is played is decreased to reduce the phenomenon of an afterimage occurring in the first frame.

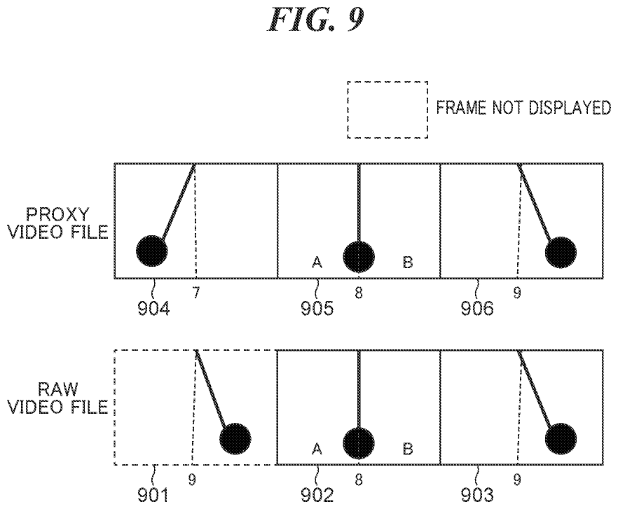

FIG. 9 is a view showing an example of a proxy video file created when a pendulum is shot, and an example of a RAW video file when it is played. Seventh to ninth frames in the proxy video file are frames 904 to 906. It is assumed that in the RAW video file, an eighth frame is a first frame 902, and a ninth frame is a frame 903 following the first frame 902. By the frames 904 to 906 of the proxy video file being sequentially played, a video in which the pendulum moves widely from the left to the right is displayed.

Assume here that as in the first embodiment described above, for the RAW video file, the control unit 109 carries out the developing process on the next frame 903 first to generate the frame 901, and carries out the cyclic NR process on the first frame 902 using the frame 901. The frame 901 has the same image as the frame 903 and used for the cyclic NR process but is not displayed. Here, in the frame 901, a ball of the pendulum swings widely to the right (in a direction of B). When the cyclic NR process is carried out on the first frame 902 using the frame 901, an afterimage of the ball occurs on the B side. The afterimage is a phenomenon that occurs due to processing between frames being performed by taking difference between an area of the ball in the frame 901 and the same area in the first frame 902.

On the other hand, for the proxy video file, the cyclic NR process is carried out on the frame 905 using the frame 904. In the frame 904, a ball of the pendulum widely swing to the left (in a direction of A). For this reason, when the cyclic NR process is carried out on the first frame 905 using the frame 904, an afterimage of the ball occurs on the A side. Namely, the directions in which the afterimage of the ball occurs are opposite to each other between the RAW video file and the proxy video file. If the directions in which afterimages occur differ between the RAW video file and the proxy video file as shown in FIG. 9, visibility will decrease due to a feeling of strangeness.

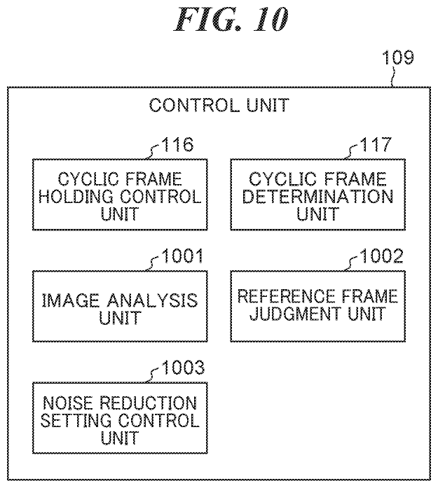

The control unit 109 according to the third embodiment carries out a process for changing settings on the cyclic NR process carried out on a first frame when a RAW video is played and reducing the phenomenon of an afterimage occurring in the first frame. FIG. 10 is a view showing an example of an arrangement of the control unit 109 according to the third embodiment.

Arrangements of components other than the control unit 109 in the image pickup apparatus 100 are the same as those in FIG. 1, and therefore, descriptions thereof are omitted. The control unit 109 includes an image analysis unit 1001, a reference frame judgment unit 1002, and a noise reduction setting control unit 1003 as well as the cyclic frame holding control unit 116 and the cyclic frame determination unit 117.

The image analysis unit 1001 analyzes images in at least two frames among frames of the RAW video and analyzes the amount of movement of the images or the amount of movement of a subject in the images. The reference frame judgment unit 1002 judges, based on the analyzed amount of movement, whether or not to use a result (image data), which has been obtained by carrying out the developing process on a frame after a first frame, as a reference frame for use in cyclic NR. The noise reduction setting control unit 1003 changes settings on the cyclic NR process, which is carried out by the image signal processing circuit 107, based on the result of the judgment by the reference frame judgment unit 1002.

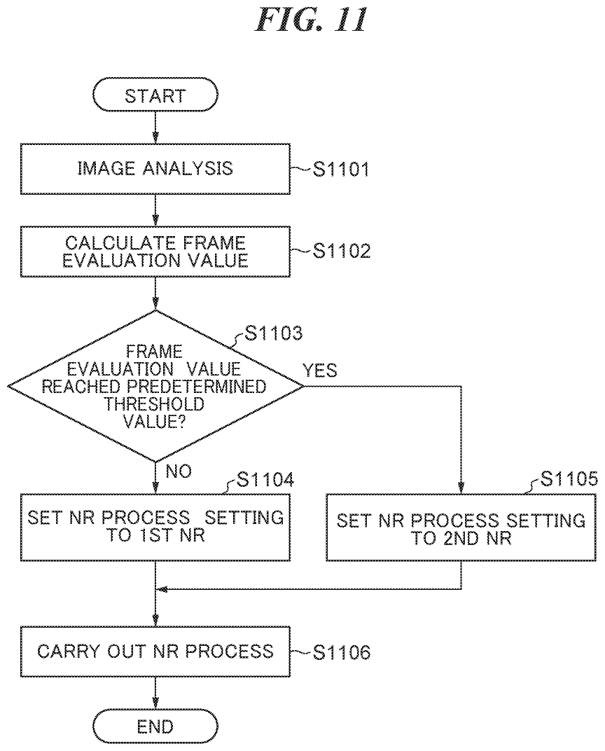

FIG. 11 is a flowchart showing the flow of a RAW video playing process according to the third embodiment. In the following description, it is assumed that the strength setting on the cyclic NR process is “Weak”, and the cyclic NR process is carried out on a first frame. The third embodiment, however, may also be applied to the case where the strength setting for the cyclic NR process is “Strong”. The process in FIG. 11 is started when, for example, the user issues an instruction to play a RAW video via the operating unit 115.

In S1101, the image analysis unit 1001 of the control unit 109 reads the frame 903 as the frame 901, which is to be used in the cyclic NR process carried out on the first frame 902 of a RAW video, as well as the first frame 902, and performs an image analysis using these two frames. At this time, the image analysis unit 1001 performs the image analysis and analyzes the amount of movement of images between the two frames. For example, the image analysis unit 1001 divides each of the images in the two frames using a predetermined number of mesh frames, and based on the similarity in the distribution of brightness values of pixels inside the mesh frames, obtains movement amount information that represents the amount of frame movement between the two frames as horizontal and vertical pixel values. It should be noted that the number of mesh frames by which an image is divided may be an arbitrary value such as “255×255”.

In S1102, the image analysis unit 1001 calculates, based on the result of the analysis in S1101, an evaluation value (frame evaluation value) that represents the tendency of an afterimage to occur. The frame evaluation value is an index of the tendency of an afterimage to occur in a frame. The image analysis unit 1001 uses a maximum value of the amount of movement of each mesh frame as the frame evaluation value. As the amount of movement of a mesh frame increases, the value of the frame evaluation value is increased. To judge whether or not a frame includes a scene in which an afterimage tends to occur, the image analysis unit 1001 may calculate the frame evaluation value using arbitrary information for detecting panning and tilting of a camera and movements of a subject. For example, in a case where a subject recognition is performed and it is judged that a frame includes a subject likely to be a moving object (a moving animal, a sport scene, etc.), the image analysis unit 1001 may set the frame evaluation value to a greater value than in a case where the subject is not a moving subject. The image analysis unit 1001 may calculate the frame evaluation value based on metadata recorded in association with the video when the video is shot and recorded.

In S1103, the reference frame judgment unit 1002 of the control unit 109 judges whether or not the frame evaluation value calculated by the image analysis unit 1001 has reached a predetermined threshold value. When the result of the judgment in S1103 is No (when the frame evaluation value has not reached the predetermined threshold value), the reference frame judgment unit 1002 (the control unit 109) proceeds the process to S1104. In this case, a frame after the first frame 902 is allowed to be used for the cyclic NR process on the first frame 902 of the RAW video file. When the result of the judgment in S1103 is No, the amount of movement between frames is not so large, and hence it is likely that the effect of an afterimage on visibility will be somewhat low.

In S1104, the noise reduction setting control unit 1003 sets the setting on the cyclic NR process to a first NR setting. The first NR setting is a setting that is applied so as to carry out the cyclic NR process according to the first or second embodiment described above. The first NR setting may be the same as a setting on the cyclic NR process carried out on a proxy video.

When the result of the judgment in S1103 is Yes (when the frame evaluation value has reached the predetermined threshold value), the reference frame judgment unit 1002 (the control unit 109) proceeds the process to S1105. In this case, a frame after the first frame 902 is not allowed to be used for the cyclic NR process on the first frame 902 of the RAW video file. In S1105, the noise reduction setting control unit 1003 sets the setting on the cyclic NR process to a second NR setting. The second NR setting is a setting that reduces afterimages.

The strength of the cyclic NR process is represented by a cyclic coefficient. The cyclic coefficient is a numeric value that represents an extent to which the effects of a difference between frames are removed. The greater the numeric value, the higher the noise reduction effect. When it is judged that the subject is a moving object (that is, the frame evaluation value is large, i.e. no less than a predetermined threshold value), a process that reduces afterimages by carrying out the cyclic noise reduction process with a reduced cyclic coefficient is carried out. In S1105, the noise reduction setting control unit 1003 may switch to a setting that intends to reduce afterimages by, for example, lowering a threshold value for the moving object judgment by the cyclic NR processing circuit.

In S1106, the control unit 109 carries out the cyclic NR process on the first frame 902 of the RAW video file with the cyclic NR process setting (the first NR setting/the second NR setting) made in S1104/S1005. In the case where the cyclic NR process is carried out with the first NR setting made in S1104, the control unit 109 carries out the cyclic NR process by using a frame after the first frame 902 as a frame for use in the cyclic NR process on the first frame 902. Namely, the same cyclic NR process as in the first embodiment and the second embodiment is carried out. On the other hand, in the case where the cyclic NR process is carried out with the second NR setting made in S1105, the control unit 109 does not use a frame after the first frame 902 as a frame for use in the cyclic NR process on the first frame 902. For this reason, in the case where the cyclic NR process is carried out with the second NR setting made in S1105, the noise reduction effect is lower, but the phenomenon of afterimages is expected to be reduced to a greater extent.

Assume here that the cyclic NR process is carried out on the first frame 902 of the RAW video file with the second NR setting made in S1105, and the cyclic NR process is carried out on the frame 903 following the first frame 902 with the first NR setting made in S1104. In this case, there is a great difference in image quality between the first frame 902 and the subsequent frame 903. In this case, for example, noise appearing when the first frame 902 is played suddenly disappears when the next frame 903 is played. Accordingly, the great difference in image quality between the two frames causes visibility to decrease.

Thus, the control unit 109 may slow down changes in image quality difference, by decreasing the amount of change in settings applied to the cyclic NR process on the first frame 902 according to that frames continue to be played at a predetermined time constant. The control unit 109 may gradually change the amount of change in the NR settings, by increasing the time constant according to that the amount of change in the cyclic NR settings for the first frame 902 increases.

Although the image analysis unit 1001 performs image analysis of frames in a RAW video file, it may perform image analysis of a proxy video file recorded at the same time when the RAW video file is recorded. In this case, the same process as above is carried out based on the result of image analysis on the proxy video file. The image analysis unit 1001 may compare the results of image analysis on developed files between the frames 904, 905 of the proxy video file and the frames 901, 902 of the RAW video file. In this case, the settings on the cyclic NR process may be changed based on the result of estimation about a difference in the direction in which an afterimage appears based on the result of the comparison.

In the third embodiment described above, by changing the settings on the cyclic NR process, the process for reducing the phenomenon of afterimages is carried out, wherein the cyclic NR process is a process that reduces noise using frame correlation. In a fourth embodiment, according to whether or not the frame evaluation value has reached the predetermined threshold value, a process that reduces afterimages is carried out by a method that does not use frame correlation. In the fourth embodiment, for example, a spatial NR process such as an epsilon filter process is applied. In the spatial NR process, information within one frame is used, and hence the phenomenon of afterimages never occurs.

In the fourth embodiment, the cyclic NR process is carried out on a first frame of a proxy video file. An NR process using an epsilon filter, which is a spatial NR process, is carried out on a first frame of a RAW video file when the phenomenon of afterimages tends to occur. The epsilon filter is strengthened by increasing a weighted ratio of a neighboring pixel area or neighboring pixels to a pixel of interest. A description will now be given of an example in which reference pixels are expanded from 3×3 pixels to 5×5 pixels to raise the noise reduction effect.

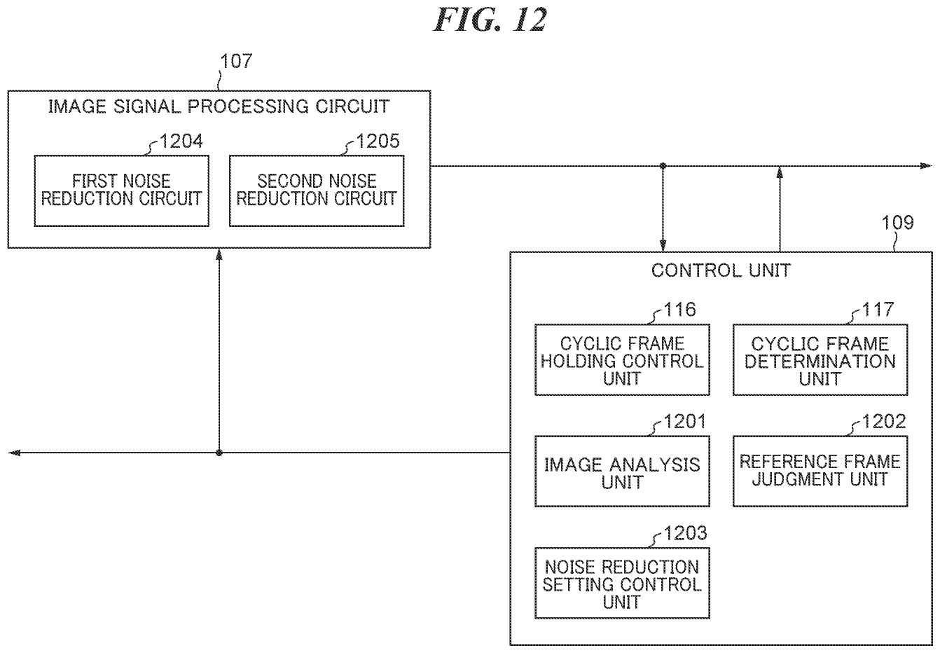

FIG. 12 is view showing examples of arrangements of the image signal processing circuit 107 and the control unit 109 according to the fourth embodiment. The same component elements of the control unit 109 as those in FIG. 10 are designated by the same reference numerals. An image analysis unit 1201 according to the fourth embodiment can also analyze metadata recorded in association with a video. The image signal processing circuit 107 includes a first noise reduction circuit 1204 that carries out an epsilon filtering process that is a spatial NR process, and a second noise reduction circuit 1205 that carries out the cyclic NR process.

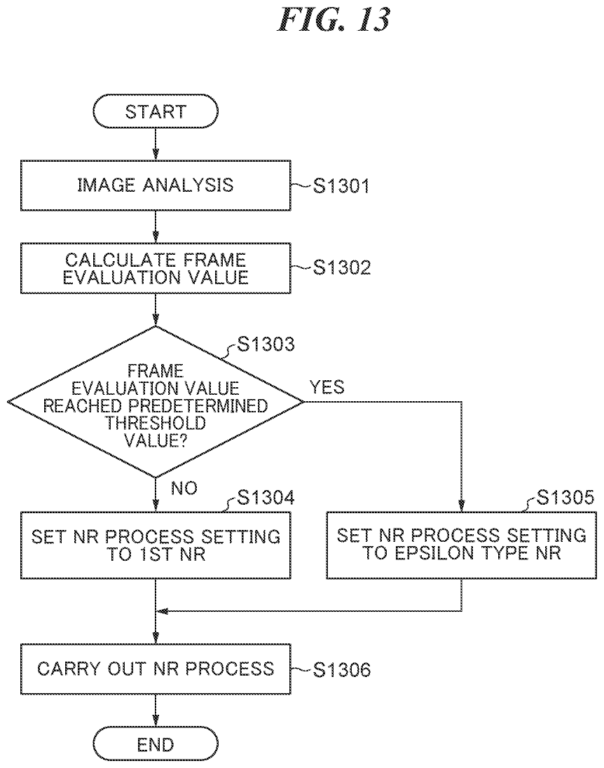

FIG. 13 is a flowchart showing the flow of a RAW video playing process according to the fourth embodiment. Processes in steps except for S1305 are the same as those in FIG. 11. Namely, the processes in S1301 to S1304 correspond to S1101 to S1104 in FIG. 11. In the fourth embodiment, when the result of the judgment by the reference frame judgment unit 1202 of the control unit 109 in S1303 is Yes (the frame evaluation value is equal to or greater than the predetermined threshold value), the noise reduction setting control unit 1203 of the control unit 109 sets the NR process setting to epsilon type NR in S1305. At this time, the noise reduction setting control unit 1203 analyzes metadata, obtains a cyclic NR setting value that was set when a proxy video file was recorded, converts the cyclic NR setting value to an epsilon filter setting (epsilon type NR) that makes the noise reduction effect substantially constant. The conversion of the setting value is performed based on, for example, a conversion setting table data where the expected noise reduction effect is close and the harmful effects is acceptable. The conversion setting table data is held in, for example, the second memory unit 114.

The cyclic NR process is adversely affected by the phenomenon of afterimages in video, and the spatial NR process is adversely affected by a decrease in resolution. In view of these adverse effects, the conversion setting table data to be prepared are adjusted to appropriate values in advance. The conversion setting table data are configured such that the cyclic NR setting is converted into the epsilon filter setting (epsilon type NR) in the following order: R1 (Weak: cyclic coefficient 2), P2 (Weak: 3×3 pixels), R2 (Strong: cyclic coefficient 4), and P2 (Strong: 5×5 pixels). Namely, the conversion setting table data are configured such that, as the noise reduction effect in the cyclic NR setting increases, the effect of a noise reduction process that is not cyclic (the epsilon filtering process that is the spatial NR process) increases. When the process in S1305 has been carried out, the epsilon NR process, which is the noise reduction process that is not cyclic, is carried out in S1306.

As described above, in the fourth embodiment, when the phenomenon of afterimages tends to occur, the spatial NR process such as the epsilon filtering process is carried out. As a result, when a RAW video file is played, the extent of afterimages appearing in a direction different from that in a proxy video file can be decreased, and the noise reduction effect can be substantially constant.

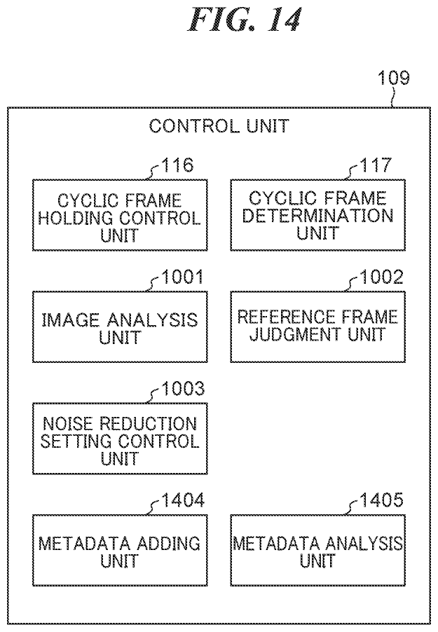

FIG. 14 is a view showing an example of an arrangement of the control unit 109 according to a fifth embodiment. The control unit 109 in FIG. 14 is comprised of a metadata adding unit 1404 and a metadata analysis unit 1405 in addition to the components of the control unit 109 in FIG. 10. The components other than the metadata adding unit 1404 and a metadata analysis unit 1405 are the same as those of the control unit 109 in FIG. 10. The image analysis unit 1001 stores information indicating the amount of movement calculated and the result of judgment by the reference frame judgment unit 1002 in the second memory unit 114. The metadata adding unit 1404 records results of computations stored in the second memory unit 114 as metadata together with image data in the recording medium 112. The metadata analysis unit 1405 stores the image data and the metadata read from the recording medium 112 in the second memory unit 114 and also analyzes the metadata. The reference frame judgment unit 1002 can refer to the result of the analysis on the metadata.

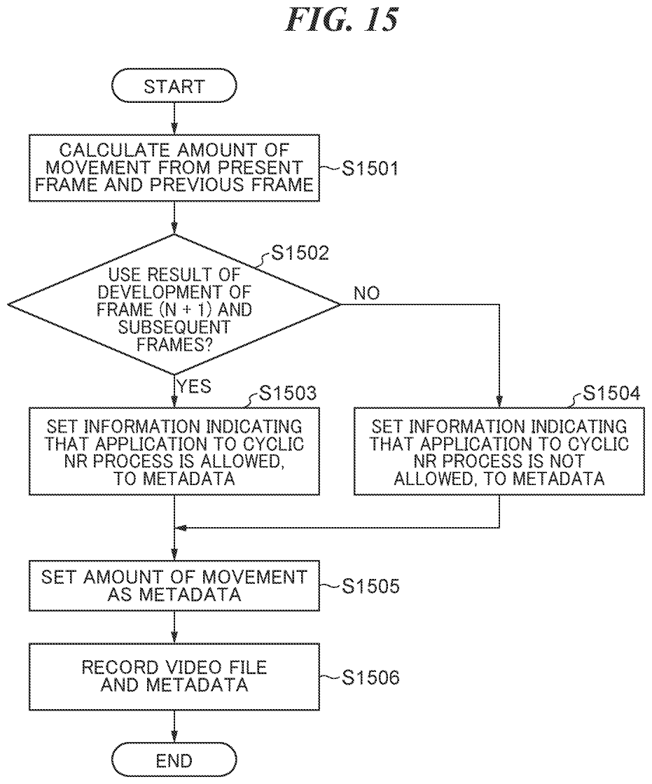

FIG. 15 is a flowchart showing the flow of a RAW video recording process according to the fifth embodiment. In the following description, it is assumed that a RAW video is recorded at a frame rate of 60 fps, but the frame rate may be an arbitrary value. The process in the flowchart of FIG. 15 is carried out on a frame-by-frame basis, for example, after the user issues an instruction to record video via the operating unit 115. It is assumed that when the recorded RAW video is to be played, the cyclic NR process is carried out on its first frame.

In S1501, the image analysis unit 1001 of the control unit 109 perform image analysis for at least two frames (a present frame and a previous frame), and based on the result of the image analysis, calculates the amount of movement. In S1502, the reference frame judgment unit 1002 of the control unit 109 judges whether or not to use the result of development of a frame (N+1) and subsequent frames as reference frames to be used for the cyclic NR process. The judgment in S1502 is made based on whether or not the amount of movement calculated in S1501 is equal to or greater than a predetermined amount. The predetermined amount can be set to an arbitrary value. For example, in S1502, the control unit 109 may make the same judgment as in S1103 in FIG. 11.

When the result of the judgment by the reference frame judgment unit 1002 in S1502 is Yes (when the result of development of the frame (N+1) and the subsequent frames is to be used), the control unit 109 proceeds the process to S1503. On the other hand, when the result of the judgment by the reference frame judgment unit 1002 in S1502 is No (when the result of development of the frame (N+1) and the subsequent frames is not to be used), the control unit 109 proceeds the process to S1504. In S1503, the metadata adding unit 1404 of the control unit 109 sets, to metadata, information indicating that the result of development of the frame (N+1) and the subsequent frame is allowed to be applied to the cyclic NR process. In S1504, the metadata adding unit 1404 sets information, to metadata, indicating that the result of development of the frame (N+1) and the subsequent frames is not allowed to be applied to the cyclic NR process.

In S1505, the metadata adding unit 1404 sets the amount of movement calculated in S1501 as metadata. In S1506, the control unit 109 records the above-described metadata as well the RAW video file in the recording medium 112.

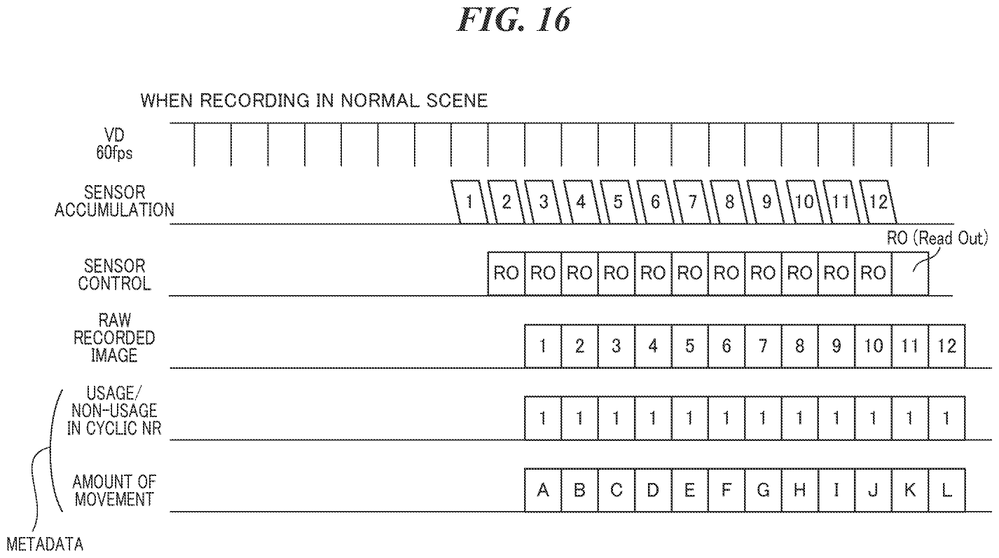

FIG. 16 is a view showing a first example of the RAW video recording process. The first example is a process that is carried out when a RAW video is shot in a normal scene in which an afterimage does not tend to be visually recognized. In the example shown in FIG. 16, a frame rate for shooting video is 60 fps. The control unit 109 reads subject images accumulated in the image pickup device 106 and causes the image signal processing circuit 107 to perform image processing on the subject images. Frames of the images subjected to the image processing are recorded as RAW recording images in the recording medium 112.

Values calculated by the image analysis unit 1001 and the cyclic frame determination unit 117 as well as the metadata described above are stored in the second memory unit 114. The first example is a process that is carried out when a RAW video is shot in a normal scene in which an afterimage does not tend to be visually recognized, and hence, in S1503, the information indicating that application to the cyclic NR process is possible is added to metadata by the metadata adding unit 1404. In the first example, the information indicating that application to the cyclic NR process is possible is recorded as a value “1” as “usage/non-usage in cyclic NR”.

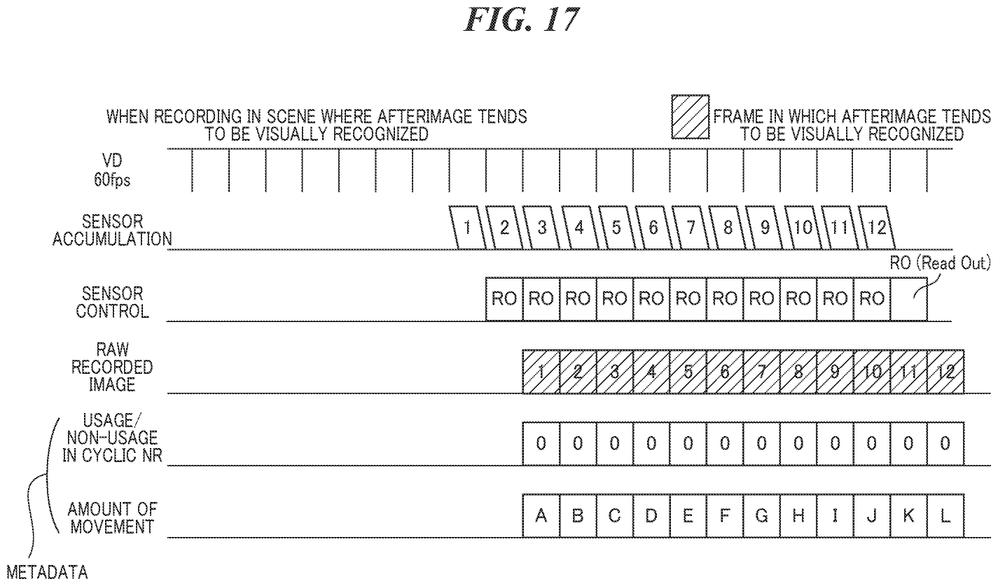

FIG. 17 is a view showing a second example of the RAW video recording process. The second example is a process that is carried out when a RAW video is shot in a scene in which an afterimage tends to be visually recognized. In images in respective frames of the RAW video in the second example, afterimages tend to be visually recognized due to a large amount of movement (indicated by stripe patterns in FIG. 17). Thus, in the second example, in S1504, information indicating that application to the cyclic NR process is impossible is added to metadata by the metadata adding unit 1404. In the second example, the information indicating that application to the cyclic NR process is impossible is recorded as a value “0” as “usage/non-usage in cyclic NR”.

In the fifth embodiment, metadata relating to the cyclic NR process as well as a RAW video can be recorded when the RAW video recording process is carried out. The fifth embodiment is useful when it is used the control according to the third or fourth embodiments is performed.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-057794, filed Mar. 30, 2021, which is hereby incorporated by reference herein in its entirety.

What is claimed is:

1. An apparatus comprising:
at least one processor that performs to:
obtain a video; and
when playing the video, subject a first frame for starting playing the video to a cyclic noise reduction process using one or more frames after the first frame.

2. The apparatus according to claim 1, wherein
a number of frames to be used in the cyclic noise reduction process varies according to a strength setting on the cyclic noise reduction process.

3. The apparatus according to claim 2, wherein
a predetermined limit is placed on the number of frames to be used in the cyclic noise reduction process.

4. The apparatus according to claim 1, wherein
one or more frames, which lie after the number of frames accumulated according to an exposure time period from the first frame, are used in the cyclic noise reduction process.

5. The apparatus according to claim 1, wherein the at least one processor further performs to:
display a screen for selecting a video from among a plurality of videos; and
while the screen is displayed, carry out a developing process on one or more frames to be used when the cyclic noise reduction process is carried out on a first frame of the currently selected video.

6. The apparatus according to claim 5, wherein when the currently selected video is changed on the screen, a developing process is carried out on one or more frames to be used when the cyclic noise reduction process on a first frame of a newly selected video.

7. The apparatus according to claim 5, wherein
in response to confirmation of a video selection on the screen, the cyclic noise reduction process is carried out on the first frame using the one or more frames that have been subjected to the developing process.

8. The apparatus according to claim 1, wherein
the one or more frames to be applied to the cyclic noise reduction process carried out on the first frame are not displayed.

9. The apparatus according to claim 1, wherein
to play a combined video obtained by combining a plurality of videos together, a frame at a point of combination is regarded as the first frame, and the cyclic noise reduction process is carried out on the first frame.

10. The apparatus according to claim 9, wherein
according to a speed at which a developing process is carried out on the frame, the cyclic noise reduction process is carried out on the frame at the point of combination while the combined video is being played, or the cyclic noise reduction process is carried out on the frame at the point of combination before the combined video is played.

11. The apparatus according to claim 10, wherein
in a case where it is possible to complete the developing process on the frame within a time period not longer than half of a play cycle of the combined video, the cyclic noise reduction process is carried out on the frame at the point of combination while the combined video is being played, and
in a case where it is not possible to complete the developing process on the frames within the time period not longer than half of the play cycle of the combined video, the cyclic noise reduction process is carried out on the frame at the point of combination before the combined video is played.

12. The apparatus according to claim 1, wherein
based on whether or not an evaluation value representing an index of a tendency of an afterimage to appear in a frame has reached a predetermined threshold value, the at least one processor determines whether or not to carry out the cyclic noise reduction process on the first frame using one or more frames after the first frame.

13. The apparatus according to claim 12, wherein
the evaluation value is calculated based on a result of an analysis on the amount of movement of an image in a frame or the amount of movement of a subject in the image.

14. The apparatus according to claim 12, wherein
when the evaluation value is equal to or greater than the predetermined threshold value, the cyclic noise reduction process with a decreased cyclic coefficient is carried out on the first frame.

15. The apparatus according to claim 12, wherein
when the evaluation value is equal to or greater than the predetermined threshold value, a noise reduction process that is not cyclic is carried out on the first frame.

16. The apparatus according to claim 15, wherein
a setting is made such that a noise reduction effect achieved by the noise reduction process that is not cyclic increases, as a noise reduction effect achieved by the cyclic noise reduction process increases.

17. The apparatus according to claim 1, wherein
information indicating whether or not one or more frames after the first frame is allowed to be used for the cyclic noise reduction process on the first frame is added to each frame of the video.

18. The apparatus according to claim 1, wherein
the video is a RAW video.

19. A method comprising:
obtaining a video; and
when playing the video, subjecting a first frame for starting playing the video to a cyclic noise reduction process using one or more frames after the first frame.

20. A non-transitory computer-readable storage medium storing a program for causing a computer to execute a method,
the method comprising:
obtaining a video; and
when playing the video, subjecting a first frame for starting playing the video to a cyclic noise reduction process using one or more frames after the first frame.
